(19) United States
(12) Patent Application Publication
(10) Pub. No.: US 2026/0084951 A1
(43) Pub. Date: Mar. 26, 2026

(54) BEVERAGE DISPENSER FOR MIXED DRINKING DISPENSING

(71) Applicant: THE COCA-COLA COMPANY, Atlanta, GA (US)

(72) Inventors: Brian B. JOHNSON, Roswell, GA (US); Akash CHAUDHURI, Atlanta, GA (US); Dick P. WELCH, Marietta, GA (US); Renika Payne DAVIS, Atlanta, GA (US)

(21) Appl. No.: 19/109,713

(22) PCT Filed: Sep. 20, 2023
(86) PCT No.: PCT/US2023/033203

§ 371 Date: Mar. 7, 2025

Related U.S. Application Data
(60) Provisional application No. 63/377,070, filed on Sep. 26, 2022.

(51) Int. Cl. B67D 1/00

(52) U.S. Cl. CPC B67D 1/0034

(57) ABSTRACT

The present application provides a beverage dispensing system for providing a mixed beverage with a flow of alcohol therein from one or more alcohol containers. The beverage dispensing system includes a nozzle, a number of micro-ingredient sources in communication with the nozzle, one or more macro-ingredient sources in communication with the nozzle, and one or more alcohol circuits in communication with the nozzle. The alcohol circuits include a manifold with the one or more alcohol containers therein and a heat exchanger to chill the flow of alcohol.

### CROSS-REFERENCE TO RELATED APPLICATIONS

This application claims priority to and benefit of U.S. Provisional Patent Application No. 63/377,070, filed Sep. 26, 2022, which is herein incorporated by reference.

### TECHNICAL FIELD

The present application and the resultant patent relate generally to beverage dispensers and more particularly relate to beverage dispensing systems equipped to accommodate various types of alcohols and the like for dispensing mixed drinks therefrom.

### BACKGROUND OF THE INVENTION

Recent improvements in beverage dispensing technology have focused on the use of micro-ingredients. With micro-ingredients, traditional beverage bases may be separated into their constituent parts at much higher dilution or reconstitution ratios. For example, the “COCA-COLA FREESTYLE®” refrigerated beverage dispensing units offered by The Coca-Cola Company of Atlanta, Georgia provide a significant increase in the number and types of beverages that may be offered by a beverage dispenser of a conventional size or footprint. Generally described, the “COCA-COLA FREESTYLE®” refrigerated beverage dispensing units create a beverage by combining a number of highly concentrated micro-ingredients with a macro-ingredient such as a sweetener and a diluent such as still or carbonated water. The micro-ingredients generally are stored in cartridges positioned within or adjacent to the beverage dispenser itself. The number and type of beverages offered by the beverage dispenser thus may be limited only by the number and type of micro-ingredient cartridges positioned therein.

Traditional bar and restaurant service of alcoholic beverages such as cocktails and other types of mixed drinks may be time consuming and may resulting in inconsistent beverages. For example, even experienced bar tenders may provide inconsistently mixed beverages during periods of high demand. There is thus a desire for improved beverage dispensing systems and the like that can accommodate the dispensing and mixing of alcoholic beverages in a fast and consistent manner.

### SUMMARY OF THE INVENTION

The present application and the resultant patent thus provide a beverage dispensing system for providing a mixed beverage with a flow of alcohol therein from one or more alcohol containers. The beverage dispensing system includes a nozzle, a number of micro-ingredient sources in communication with the nozzle, one or more macro-ingredient sources in communication with the nozzle, and one or more alcohol circuits in communication with the nozzle. The alcohol circuits include a manifold with the one or more alcohol containers therein and a heat exchanger for chilling the flow of alcohol.

The present application and the resultant patent further may provide a method of dispensing a beverage from a nozzle. The method may include the steps flowing a number of micro-ingredients to the nozzle, flowing a volume of diluent to the nozzle, flowing a volume of alcohol to the nozzle, and reducing the volume of the flow of diluent by the volume of the flow of alcohol.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of an exemplary beverage dispensing system.

FIG. 2 is a plan view of an embodiment of the beverage dispensing system of FIG. 1.

FIG. 3 is a schematic diagram of an alcohol circuit for use with the beverage dispensing system of FIG. 1 as may be described herein.

FIG. 4 is a schematic diagram of an alternative alcohol circuit for use with the beverage dispensing system of FIG. 1.

FIG. 5 is a schematic diagram of an alternative alcohol circuit for use with the beverage dispensing system of FIG. 1.

FIG. 6 is a perspective view of an exemplary beverage dispensing system with one or more alcohol circuits therein.

### DETAILED DESCRIPTION

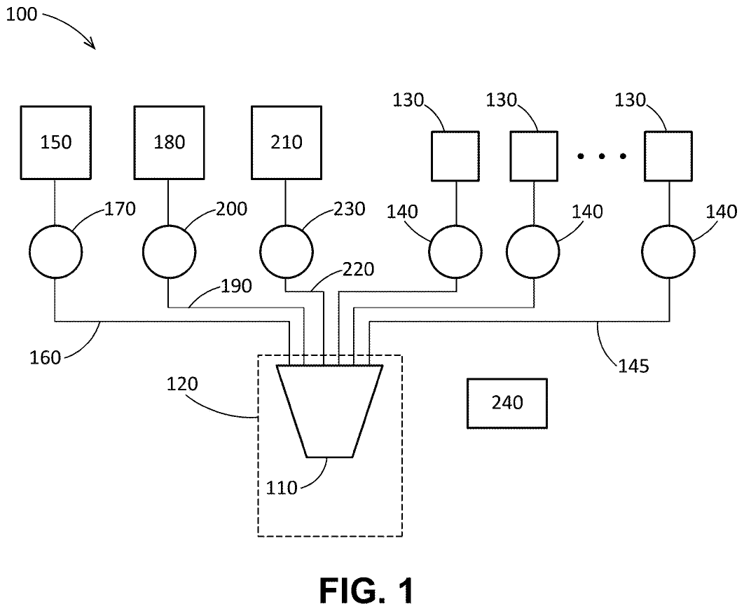

Referring now to the drawings, in which like numerals refer to like elements throughout the several views, FIG. 1 shows an example of a beverage dispensing system 100 as may be described herein. The beverage dispensing system 100 may be used for dispensing many different types of beverages. Specifically, the beverage dispensing system 100 may be used with diluents, macro-ingredients, micro-ingredients, and other types of fluids. The diluents generally include plain water (still water or non-carbonated water), carbonated water, and other fluids. Any type of fluid may be used herein.

Generally described, the macro-ingredients may have reconstitution ratios in the range from full strength (no dilution) to about six (6) to one (1) (but generally less than about ten (10) to one (1)). The macro-ingredients may include sugar syrup, HFCS (“High Fructose Corn Syrup”), concentrated extracts, purees, and similar types of ingredients. Other ingredients may include dairy products, soy, and rice concentrates. Similarly, a macro-ingredient base product may include the sweetener as well as flavorings, acids, and other common components as a beverage syrup. The beverage syrup with sugar, HFCS, or other macro-ingredient base products generally may be stored in a conventional bag-in-box container remote from the beverage dispenser. The viscosity of the macro-ingredients may range from about 1 to about 10,000 centipoise and generally over 100 centipoises when chilled. Other types of macro-ingredients and the like may be used herein.

The micro-ingredients may have reconstitution ratios ranging from about ten (10) to one (1) and higher. Specifically, many micro-ingredients may have reconstitution ratios in the range of about 20:1, to 50:1, to 100:1, to 300:1, or higher. The viscosities of the micro-ingredients typically range from about one (1) to about six (6) centipoise or so, but may vary from this range. Examples of micro-ingredients include natural or artificial flavors; flavor additives; natural or artificial colors; artificial sweeteners (high potency, nonnutritive, or otherwise); antifoam agents, nonnutritive ingredients, additives for controlling tartness, e.g., citric acid or potassium citrate; functional additives such as vitamins, minerals, herbal extracts, nutraceuticals; and over the counter (or otherwise) medicines such as turmeric, acetaminophen; and similar types of ingredients. Various types of alcohols may be used as either macro-ingredients or micro-ingredients. The micro-ingredients may be in liquid, gaseous, or powder form (and/or combinations thereof including soluble and suspended ingredients in a variety of media, including water, organic solvents, and oils). Other types of micro-ingredients may be used herein.

The various fluids used herein may be mixed in or about a dispensing nozzle 110. The dispensing nozzle 110 may be a conventional multi-flavor nozzle and the like. The dispensing nozzle 110 may have any suitable size, shape, or configuration. The dispensing nozzle 110 may be positioned within a dispensing tower 120. The dispensing tower 120 made have any suitable size, shape, or configuration. The dispensing tower 120 may extend from a countertop and the like and/or the dispensing tower 120 may be a free-standing structure. The dispensing tower 120 may have a number of the dispensing nozzles 110 thereon.

The micro-ingredients may be stored in a number of micro-ingredient containers 130 or other types of micro-ingredient sources. The micro-ingredient containers 130 may have any suitable size, shape, or configuration. Any number of the micro-ingredient containers 130 may be used herein. The micro-ingredient containers 130 may be in communication with the dispensing nozzle 110 via a number of micro-ingredient pumps 140 positioned on a number of micro-ingredient conduits 145. The micro-ingredient pumps 140 will be described in more detail below and made have any suitable volume or capacity. The micro-ingredient containers 130 may be positioned in, adjacent to, and/or remote from the dispensing nozzle 110. For example, the micro-ingredient containers 130 may be positioned under the counter top upon which the dispensing tower 120 rests. Some or all of the micro-ingredient containers 130 may be agitated.

A still water source 150 may be in communication with the dispensing nozzle 110 via a still water conduit 160. Other types of diluents may be used herein. Still water or other types of diluents may be pumped to the dispensing nozzle 110 via a still water pump 170. The still water pump 170 may be may be any type of conventional fluid moving device and made have any suitable volume or capacity. Alternatively, the pressure in a conventional municipal water source may be sufficient without the use of a pump. Any number of still water sources 150 may be used herein.

A carbonated water source 180 may be in communication with the dispensing nozzle 110 via a carbonated water conduit 190. The carbonated water source 180 may be a conventional carbonator and the like. The carbonator may have any suitable size, shape, or configuration. Carbonated water or other types of diluents may be pumped to the dispensing nozzle 110 via a carbonated water pump 200. The carbonated water pump 200 may be any type of conventional fluid moving device and made have any suitable volume or capacity. Any number of carbonated water sources 180 may be used herein. A carbonated water recirculation line also may be used herein.

One or more macro-ingredient sources 210 may be in communication with the dispensing nozzle 110 via one or more macro-ingredient conduits 220. As described above, the macro-ingredient sources 210 may include sweeteners such as high fructose corn syrup, sugar solutions, and the like. The macro-ingredient sources 210 may be a conventional bag-in-box or other type of container in any suitable size, shape, or configuration. Any number of the macro-ingredient sources 210 may be used herein. The macro-ingredients may flow to the dispensing nozzle 110 via a macro-ingredient pump 230. In this case, the macro-ingredient pump 230 may be a controlled gear pump and the like. Other types of pumps may be used herein.

Operation of the beverage dispensing system 100 and the component therein may be controlled by a control device 240. The control device 240 may be a conventional microcomputer and the like capable of executing programmable commands. The control device 240 may be internal or external from the beverage dispensing system 100. The functionality of the control device 240 may be implemented in software, firmware, hardware, or any combination thereof. One control device 240 may control multiple beverage dispensing systems 100 and/or one beverage dispensing system 100 may have multiple control devices 240 with specific tasks.

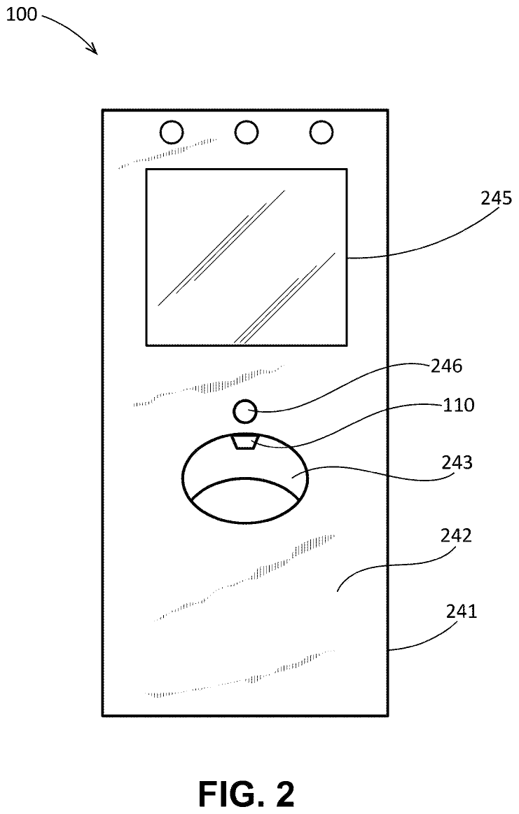

As is shown in FIG. 2, the beverage dispensing system 100 may include an outer shell 241 with an access door 242 thereon. The micro-ingredient cartridges 130 and other types of beverage ingredients and the like may be loaded through the access door 242. The outer shell 241 may define a dispensing area 243 with one or more dispensing nozzles 110. The beverage dispensing system 100, and the components thereof, may have any suitable size, shape, or configuration.

The beverage dispensing system 100 may include a graphical user interface 245 positioned thereon. The graphical user interface 245 may include a video screen and the like so as to allow a consumer to select any number of different beverage or product brands, types, and/or formulations. The graphical user interface 245 may present the consumer with a series of dynamically generated menus and/or static menus. Selecting a menu item may cause the beverage dispensing system 100 to formulate and dispense the beverage. The graphical user interface 245 also may display any type of graphics, messaging, video, and the like. Sound also may be incorporated herein. One or more separate display screens, banner screens, and the like also may be used. Different types of mechanical and/or electro-mechanical push buttons, such as a pour button 246 and the like, also may be used. Other types of consumer interfaces may be used herein. Other components and other configurations also may be used herein.

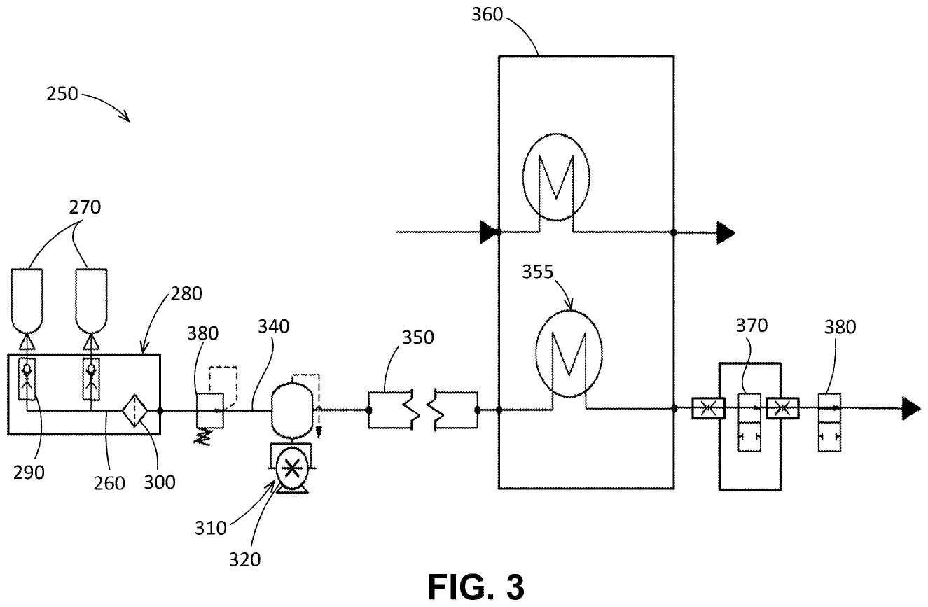

FIG. 3 shows a further embodiment of the beverage dispensing system 100. In this example, the beverage dispensing system 100 includes one or more alcohol circuits 250. The alcohol circuits 250 may be standalone systems and/or the alcohol circuits 250 may be integrated into the respective components of the beverage dispensing system 100 as a whole. The alcohol circuits 250 may accommodate any number of flows of alcohol 260 as stored in conventional alcoholic beverages containers 270 such as bottles of any size, shape, or volume.

The alcohol circuits 250 may include a manifold 280. The manifold 280 may accommodate any number of the alcoholic beverage containers 270 therein with each container 270 being positioned within a manifold valve 290. Generally described, each manifold valve 290 may be configured to accommodate major brands therein of typical volume, i.e., 750 ml, 1.75 liter bottles, and the like. Preferably the overall manifold 280 does not need priming and has very little waste during change out with little product remnant. An optical scanner and the like may be used as a sold out detector to determine when a container 270 is empty or near empty. A product strainer or filter 300 may be used herein. Any type of strainer or filter 300 may be used herein. Other components and other configurations may be used herein.

Each alcohol circuit 250 may include a pump 310 downstream of the manifold 280. In this example, a macro-ingredient pump 230 such as a controlled gear pump 320 and the like may be used. The controlled gear pump 320 may be of conventional design. A vacuum or pressure regulator 330 and the like also may be used. Each alcohol circuit 250 may extend from the manifold 280 and through the controlled gear pump 320 or other type of pump 310 via an alcohol conduit 340. The alcohol conduits 340 may be any type of flexible tubing and the like of any length. Any number of conduits 340 may be combined together in a python 350. Other components and other configurations may be used herein.

The alcohol conduits 340 may extend through a heat exchanger 355 such as a cold plate 360 and the like. The cold plate 360 or other type of heat exchanger 355 may be an existing components in the beverage dispensing system 100 as a whole and may be used to chill the alcohol, the carbonated water, the still water, or any of the other ingredients herein. The flow of alcohol 260 then may be delivered to the nozzle 110 so as to mix with the other ingredients therein in a conventional fashion to create the selected beverage. A backblock valve 370 and/or a shut-off valve 380 also may be used herein. The valves may be of conventional design. Other components and other configurations may be used herein.

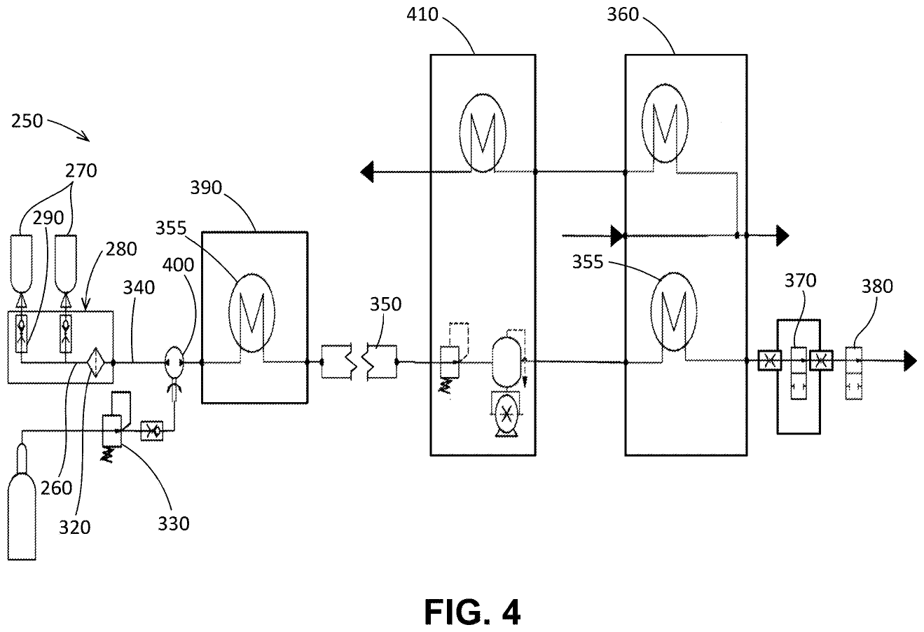

FIG. 4 shows a further embodiment of the alcohol circuit 250. In this example, the flow of alcohol 260 may be chilled before entry into the controlled gear pump 320. Specifically, the flow of alcohol 260 may be pumped to a remote chiller 390 or other type of heat exchanger 355 via the pump 310. The remote chiller 390 may be a cold plate or any type of heat exchanger. The pump 310 may be a conventional carbon dioxide pump 400 typically used with Bag In Box containers and the like to pump syrups and other types of macro-ingredients. The controlled gear pump 320 therefore may be positioned within an insulated enclosure 410 and the like to maintain the temperature of the chilled flow of alcohol 260. The flow of alcohol 260 may again pass through the cold plate 360 or other type of heat exchanger 355 on the way to the nozzle 110. Other components and other configurations may be used herein.

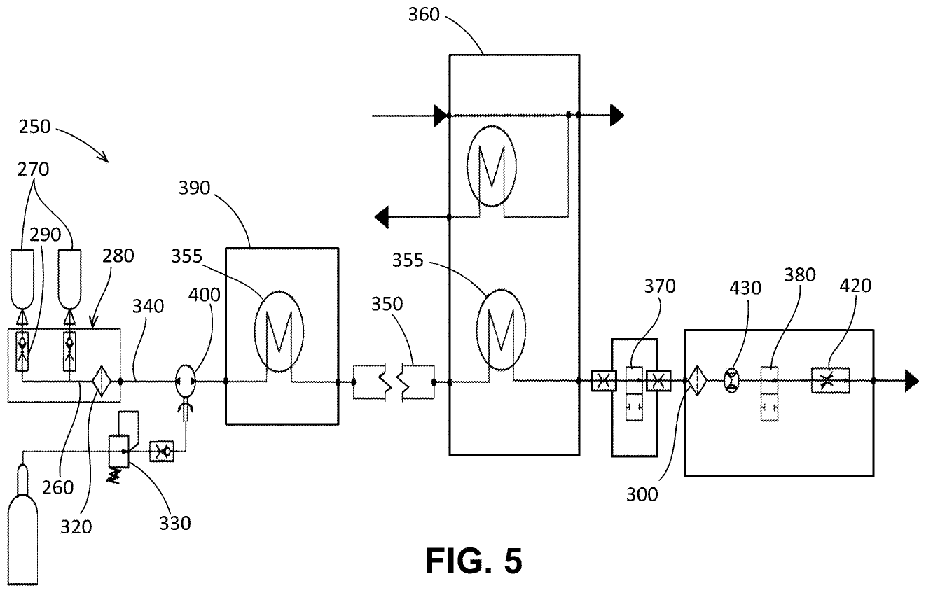

FIG. 5 shows a further embodiment of the alcohol circuit 250. In this example, a proportional control valve 420 and a flow meter 430 and may be used instead of the controlled gear pump 320 or other type of pump 310. The flow of alcohol 260 may be pumped by the carbon dioxide pump 400 through the remote chiller 390 and the cold plate 360. The proportional control valve 420 then accurately doses the flow of alcohol 260 to the nozzle 110 as determined by the flow meter 430. Other components and other configurations may be used herein.

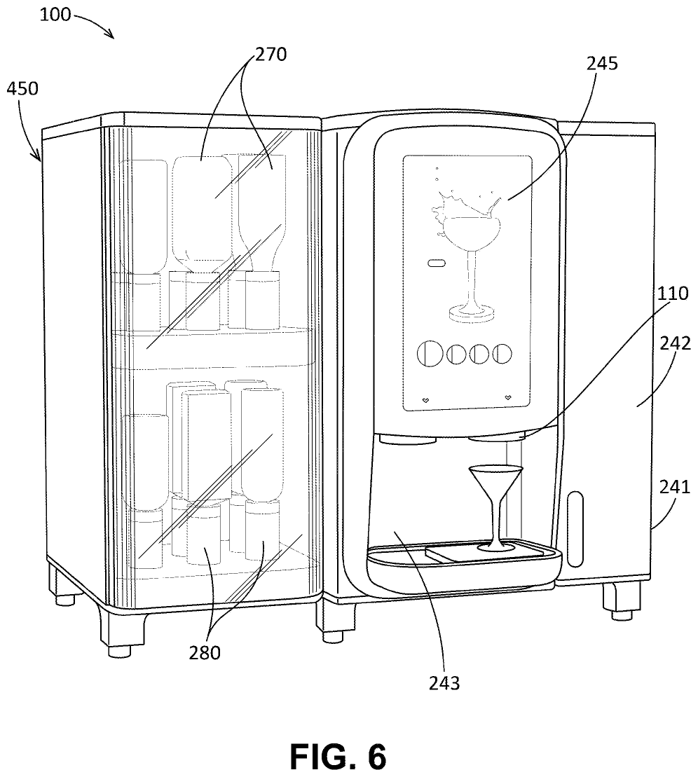

FIG. 6 shows an example of the beverage dispensing system 100 with a number of alcohol circuits 250 therein. As is shown, the beverage dispensing system 100 includes the outer shell 241, the access door 242, the dispensing area 243 with one or more nozzles 110 therein, and the graphical user interface 245. Other configurations may be used herein. The beverage dispensing system 100 also includes a side car 450 with a number of the alcohol containers 270 of the alcohol circuits 250 visible therein. Each of the alcohol containers 270 may be prominently displayed to the consumer. Each of the alcohol containers 270 may be positioned within the manifold 280 of the respective alcohol circuit 250. The beverage dispensing system 100 may have a scanner or other type of device to check identification and the like for age verification or user authorization, i.e., only crew members may have access to the beverage dispensing system 100. The beverage dispensing system 100 also may have a printer to print order tickets, guest checks, receipts, and the like.

In use, the consumer or a crew member may approach the beverage dispensing system 100 and may select a beverage from the graphical user interface 245. The graphical user interface 245 may suggest different types of beverages, combinations, flavors, additives, and the like. For example, specialty cocktails may be offered. Once a selection is made, the control device 240 may determine the appropriate recipe for the selected beverage. The recipe may include the volume and flow rate of the micro-ingredients, the macro-ingredients, and the diluent. In this example, most types of alcohols may fall into the macro-ingredient category with respect to reconstitution ratios, viscosity, flow rates, and the like, although certain types of additives, such as aromatic bitters may fall into the micro-ingredient category. Given the use of alcohol, a water flush may be performed after each pour to flush the overall system 100 and the nozzle 110 of any residual alcohol therein.

One issue with the use of mixed beverages, is that the alcohol tends to melt the ice therein that may lead to a beverage with a watered-down taste. If the typical beverage has about fifteen percent (15%) micro-ingredients and macro-ingredients and about eighty-five percent (85%) chilled carbonated water, than the volume of water may be reduced by the volume of alcohol added. As a result, a mixed beverage with alcohol may have fifteen percent (15%) micro-ingredients and macro-ingredients, about seventy-two (72%) percent chilled carbonated water, and about thirteen percent (13%) alcohol. The overall flavor profile of the selected beverage may further increase by also chilling the alcohol. The respective percentages described herein may vary by beverage. The beverage dispensing system 100 also may accommodate differently sized beverages, i.e., the same volume of alcohol but more mixers in a larger glass, as well as requests for “doubles” for beverages with more alcohol and the like. In either situation, the beverage dispensing system 100 provides the correct ratios for the desired beverage.

The beverage dispensing system 100 described herein thus provides advantages for both the consumer and the beverage provider. The consumer receives faster service and a consistently better tasting drink. The beverage provider receives precisely measured drinks which are easier and faster to provide to the consumer. This ability may allow, for example, a bar tender to focus on more complex or top-tier drinks. Moreover, the beverage dispensing system 100 may provide detailed analytics on the selected beverages. Likewise, the beverage dispensing system 100 may be easily updated with different ingredients and recipes.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A beverage dispensing system for providing a mixed beverage with a flow of alcohol therein from one or more alcohol containers, comprising:
a nozzle;
a plurality of micro-ingredient sources in communication with the nozzle;
one or more macro-ingredient sources in communication with the nozzle; and
one or more alcohol circuits in communication with the nozzle;
the one or more alcohol circuits comprising a manifold with the one or more alcohol containers therein; and
the one or more alcohol circuits comprising a heat exchanger to chill the flow of alcohol.

2. The beverage dispensing system of claim 1, wherein the plurality of micro-ingredient sources comprises reconstitution ratios of about ten to one or higher.

3. The beverage dispensing system of claim 1, further comprising one or more diluent sources in communication with the nozzle.

4. The beverage dispensing system of claim 1, wherein the one or more alcohol circuits comprise a strainer therein.

5. The beverage dispensing system of claim 1, wherein the one or more alcohol circuits comprise a pump therein.

6. The beverage dispensing system of claim 5, wherein the pump comprises a controlled gear pump.

7. The beverage dispensing system of claim 5, wherein the pump comprises a carbon dioxide pump.

8. The beverage dispensing system of claim 1, wherein the one or more alcohol circuits comprise a pressure regulator therein.

9. The beverage dispensing system of claim 1, further comprising a cold plate with the heat exchanger therein.

10. The beverage dispensing system of claim 1, further comprising a remote chiller with the heat exchanger therein.

11. The beverage dispensing system of claim 1, wherein the one or more alcohol circuits comprise a flow meter therein.

12. The beverage dispensing system of claim 11, wherein the one or more alcohol circuits comprise a proportional control valve therein.

13. The beverage dispensing system of claim 1, wherein the one or more alcohol circuits comprise a shut off valve.

14. The beverage dispensing system of claim 1, further comprising a side car with the manifold therein.

15. A method of dispensing a beverage from a nozzle, comprising:
flowing a plurality of micro-ingredients to the nozzle;
flowing a volume of diluent to the nozzle;
flowing a volume of alcohol to the nozzle; and
reducing the volume of the flow of the diluent by the volume of the flow of alcohol.
